(19) United States
(12) Patent Application Publication
(10) Pub. No.: US 2026/0081064 A1
(43) Pub. Date: Mar. 19, 2026

(54) MAGNETIC COMPONENT

(71) Applicant: CYNTEC CO., LTD., Hsinchu (TW)

(72) Inventors: Sen-Huei Chen, Hsinchu (TW); Chi-Shiuan Shie, Hsinchu (TW); Mo-Yang Lu, Hsinchu (TW)

(73) Assignee: CYNTEC CO., LTD., Hsinchu (TW)

(21) Appl. No.: 19/403,222

(22) Filed: Nov. 27, 2025

Related U.S. Application Data
(63) Continuation-in-part of application No. 19/011,543, filed on Jan. 6, 2025.
(60) Provisional application No. 63/618,396, filed on Jan. 8, 2024.
(60) Provisional application No. 63/726,334, filed on Nov. 29, 2024.

(51) Int. Cl. H01F 27/28; H01F 27/32; H01F 27/34

(52) U.S. Cl. CPC H01F 27/2852; H01F 27/323; H01F 27/346

(57) ABSTRACT

A magnetic component includes a magnetic body, a first winding, a second winding and a magnetic filler. The first winding is disposed in the magnetic body. A first end and a second end of the first winding respectively extend towards a first side and a second side of the magnetic body. The second winding is disposed in the magnetic body. A third end and a fourth end of the second winding extend towards the first side of the magnetic body. The first winding partially covers the second winding. The magnetic filler is filled between the first winding and the second winding.

### CROSS REFERENCE TO RELATED APPLICATIONS

This application is a continuation-in-part of U.S. application Ser. No. 19/011,543, filed on Jan. 6, 2025, which claims the benefit of U.S. Provisional Application No. 63/618,396, filed on Jan. 8, 2024. Further, this application claims the benefit of U.S. Provisional Application No. 63/726,334, filed on Nov. 29, 2024. The contents of these applications are incorporated herein by reference.

### BACKGROUND OF THE INVENTION

### 1. Field of the Invention

The invention relates to a magnetic component and, more particularly, to a magnetic component capable of controlling leakage inductance.

### 2. Description of the Related Art

An inductor is an important magnetic component used for filtering, energy storage, and voltage regulation. In most of circuits, there is always an inductor installed therein. In general, the electromagnetic coupling and voltage stability are closely related to leakage inductance of the inductor. In other words, leakage inductance determines the quality of energy coupling. Thus, how to control leakage inductance of the inductor has become a significant design issue.

### SUMMARY OF THE INVENTION

The invention provides a magnetic component capable of controlling leakage inductance, so as to solve the aforesaid problems.

According to an embodiment of the invention, a magnetic component comprises a magnetic body, a first winding, a second winding and a magnetic filler. The first winding is disposed in the magnetic body. A first end and a second end of the first winding respectively extend towards a first side and a second side of the magnetic body. The second winding is disposed in the magnetic body. A third end and a fourth end of the second winding extend towards the first side of the magnetic body. The first winding partially covers the second winding. The magnetic filler is filled between the first winding and the second winding.

In an embodiment, a number of turns of the first winding are less than one.

In an embodiment, a number of turns of the second winding are less than or equal to one.

In an embodiment, the first side is opposite to the second side.

In an embodiment, two isolation grooves are formed on the first side and a third side of the magnetic body, are located between the first winding and the second winding, and run through the magnetic body, wherein the third side is connected between the first side and the second side.

In an embodiment, each of the two isolation grooves comprises a gap and the magnetic filler is filled in the gap.

In an embodiment, a cross-section of the gap is triangular.

In an embodiment, the first end extends from a turning corner of the first winding, such that the magnetic body forms a triangular portion adjacent to the first winding.

In an embodiment, the third end extends horizontally to form an electrode and the fourth end extends vertically to form another electrode.

In an embodiment, the first winding and the second winding are covered by insulation layers, wherein the first end, the second end, the third end and the fourth end exposed from the insulation layers are formed with electrodes.

In an embodiment, a cross-section of the first winding is greater than a cross-section of the second winding.

According to another embodiment of the invention, a magnetic component comprises a magnetic body, a plurality of first windings, a plurality of second windings and a plurality of magnetic fillers. The plurality of first windings are disposed in the magnetic body and arranged at intervals. A first end and a second end of each of the plurality of first windings respectively extend towards a first side and a second side of the magnetic body. The plurality of second windings are disposed in the magnetic body and arranged at intervals. A third end and a fourth end of each of the plurality of the second windings extend towards the first side of the magnetic body. The plurality of first windings respectively partially cover the plurality of second windings. The plurality of magnetic fillers are filled between the plurality of first windings and the plurality of second windings.

In an embodiment, two isolation grooves are formed on the first side and a third side of the magnetic body, are located between the plurality of first windings and the plurality of the second windings, and run through the magnetic body, wherein the third side is connected between the first side and the second side.

In an embodiment, each of the two isolation grooves comprises a gap and the plurality of magnetic fillers are filled in the gap.

In an embodiment, a cross-section of the gap is triangular.

In an embodiment, the magnetic component further comprises a plurality of isolation rings surrounding a periphery of the magnetic body, wherein the plurality of isolation rings engage with the two isolation grooves.

In an embodiment, one of the plurality of first windings and one of the plurality of second windings are located between two of the plurality of isolation rings.

In an embodiment, each of the plurality of isolation rings is partially embedded in the magnetic body and partially exposed from the magnetic body.

In an embodiment, the plurality of isolation rings are made of insulation material.

In an embodiment, the magnetic component further comprises two ground electrodes disposed at opposite sides of the magnetic body, wherein the plurality of first windings and the plurality of second windings are located between the two ground electrodes.

In an embodiment, a number of turns of each of the plurality of first windings are less than one.

In an embodiment, a number of turns of each of the plurality of second windings are less than or equal to one.

In an embodiment, the first side is opposite to the second side.

As mentioned in the above, the magnetic filler is filled between the first winding and the second winding. Therefore, the invention can control the leakage inductance and the transient inductance of the magnetic component by adjusting the magnetic permeability of the magnetic filler and/or by adjusting the gap between the first winding and second winding, thereby improving the electromagnetic coupling and voltage stability in a circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a magnetic component according to an embodiment of the invention.

FIG. 2 is a perspective view illustrating the magnetic component shown in FIG. 1 from another viewing angle.

FIG. 3 is an exploded view illustrating the magnetic component shown in FIG. 1.

FIG. 4 is a sectional view illustrating the magnetic component shown in FIG. 1.

FIG. 5 is a partial enlarged view illustrating a first winding and an electrode shown in FIG. 4.

FIG. 6 is a partial enlarged view illustrating the first winding, a second winding and three electrodes shown in FIG. 4.

FIG. 7 is a perspective view illustrating a magnetic component according to another embodiment of the invention.

FIG. 8 is a perspective view illustrating the magnetic component shown in FIG. 7 from another viewing angle.

FIG. 9 is an exploded view illustrating the magnetic component shown in FIG. 7.

FIG. 10 is a perspective view illustrating a magnetic component according to another embodiment of the invention.

FIG. 11 is a sectional view illustrating the magnetic component shown in FIG. 10.

FIG. 12 is a sectional view illustrating the magnetic component shown in FIG. 10.

### DETAILED DESCRIPTION

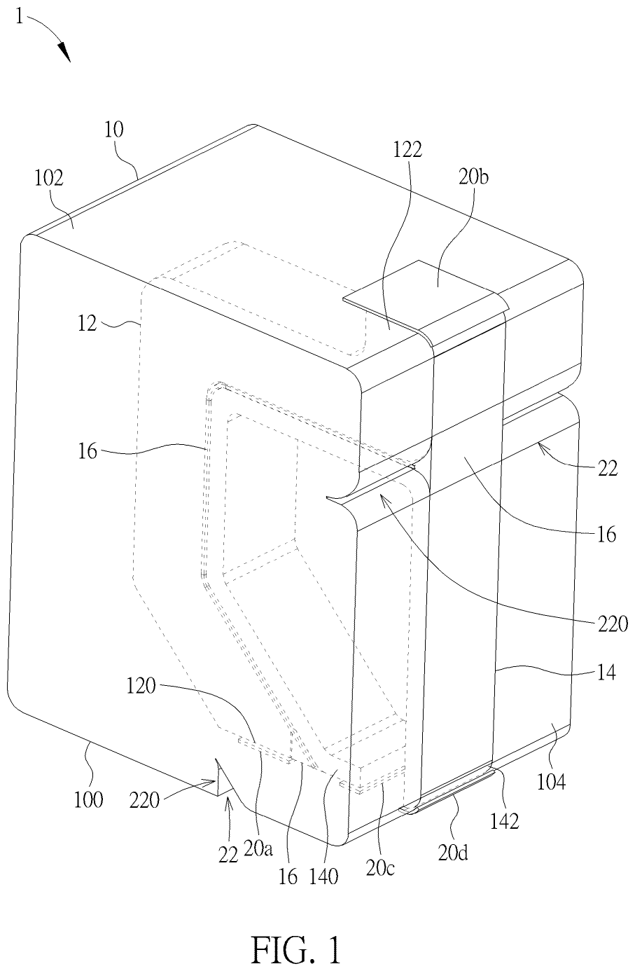

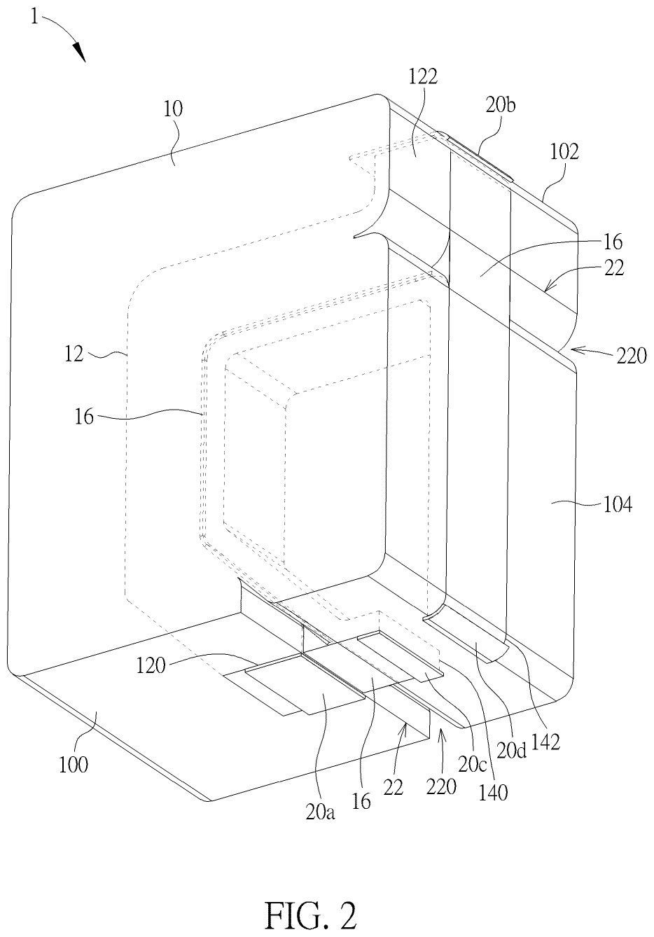

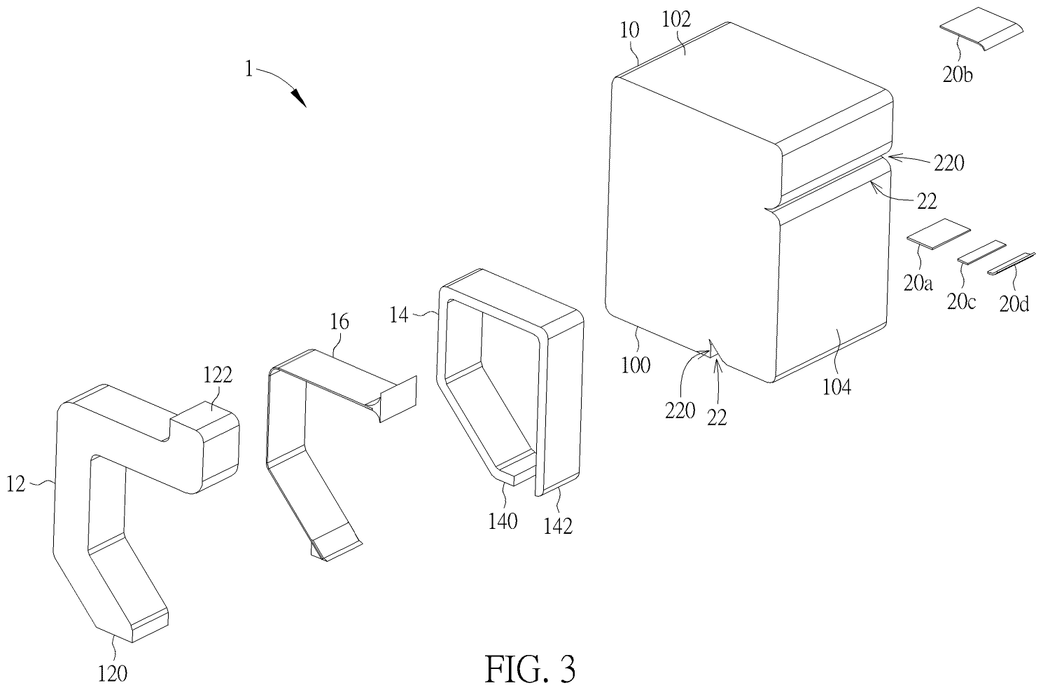

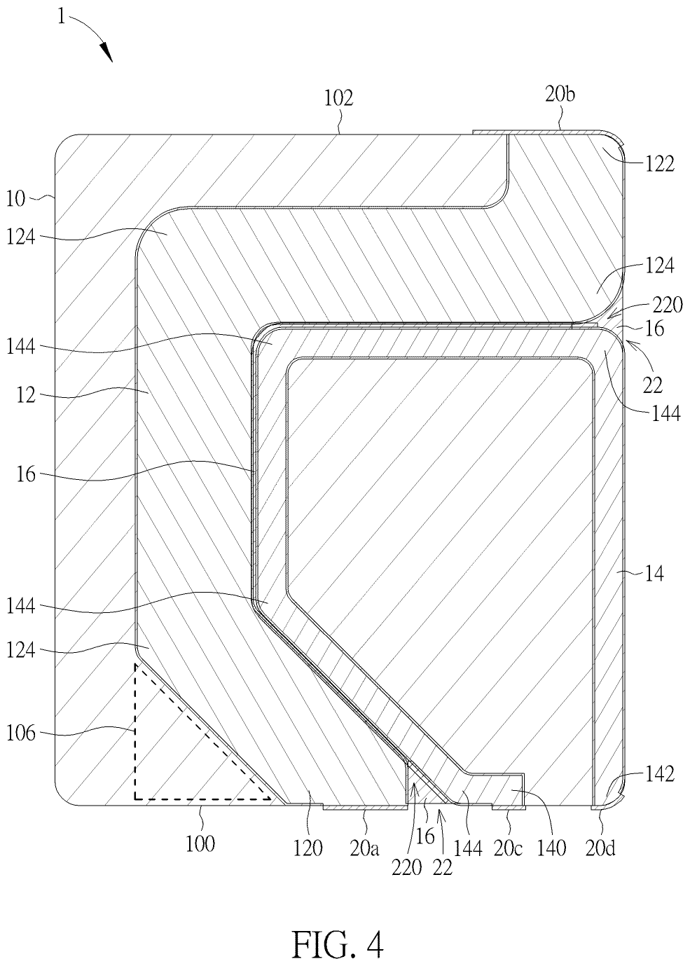

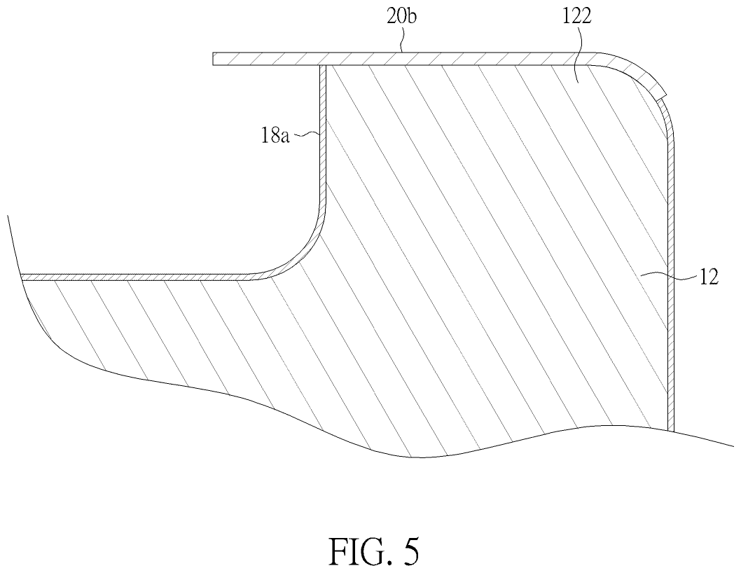

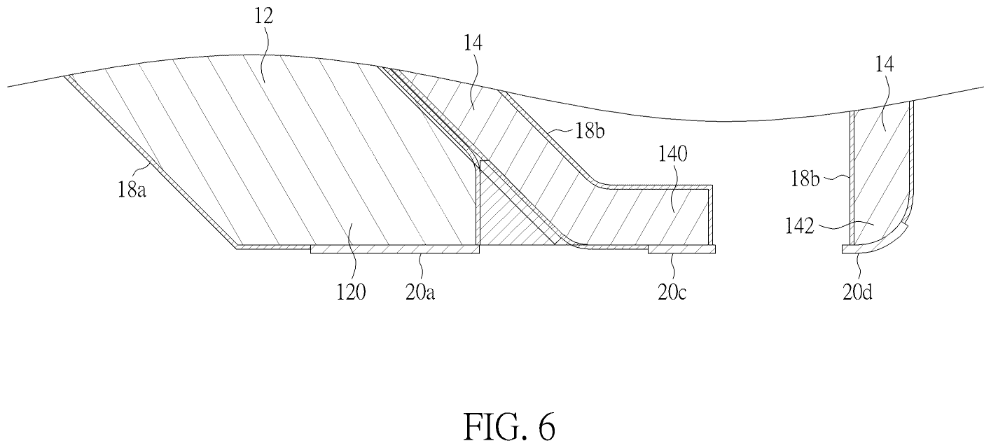

Referring to FIGS. 1 to 6, FIG. 1 is a perspective view illustrating a magnetic component 1 according to an embodiment of the invention, FIG. 2 is a perspective view illustrating the magnetic component 1 shown in FIG. 1 from another viewing angle, FIG. 3 is an exploded view illustrating the magnetic component 1 shown in FIG. 1, FIG. 4 is a sectional view illustrating the magnetic component 1 shown in FIG. 1, FIG. 5 is a partial enlarged view illustrating a first winding 12 and an electrode 20b shown in FIG. 4, and FIG. 6 is a partial enlarged view illustrating the first winding 12, a second winding 14 and three electrodes 20a, 20c, 20d shown in FIG. 4.

The magnetic component 1 of the invention may be an inductor or other magnetic components. As shown in FIGS. 1 to 4, the magnetic component 1 comprises a magnetic body 10, a first winding 12, a second winding 14 and a magnetic filler 16. The first winding 12 is disposed in the magnetic body 10, wherein a first end 120 and a second end 122 of the first winding 12 respectively extend towards a first side 100 and a second side 102 of the magnetic body 10. In this embodiment, the first side 100 may be opposite to the second side 102. That is to say, the first end 120 and the second end 122 of the first winding 12 extend towards different sides of the magnetic body 10. The second winding 14 is disposed in the magnetic body 10, wherein a third end 140 and a fourth end 142 of the second winding 14 extend towards the first side 100 of the magnetic body 10. That is to say, the third end 140 and the fourth end 142 of the second winding 14 extend towards the same side of the magnetic body 10. Thus, the first end 120 of the first winding 12 and the third end 140 and the fourth end 142 of the second winding 14 are located at the first side 100 of the magnetic body 10, while the second end 122 of the first winding 12 is located at the second side 102 of the magnetic body 10. When the first winding 12 and the second winding 14 are packaged in the magnetic body 10, the first winding 12 partially covers the second winding 14, as shown in FIG. 4. In this embodiment, parts of the second winding 14 located at the first side 100 and a third side 104 of the magnetic body 10 are not covered by the first winding 12, wherein the third side 104 is connected between the first side 100 and the second side 102.

The magnetic body 10 may be formed integrally by a magnetic material, and the first winding 12 and the second winding 14 may be made of copper. In practical applications, the first winding 12 may be a primary winding of the magnetic component 1 and the second winding 14 may be a secondary winding of the magnetic component 1.

In this embodiment, a number of turns of the first winding 12 may be less than one, and a number of turns of the second winding 14 may be less than or equal to one. It should be noted that the shapes of the first winding 12 and the second winding 14 may be determined according to practical applications, so the invention is not limited to the embodiment shown in the figure.

In this embodiment, each of the first winding 12 and the second winding 14 may be bent to form a plurality of turning corners 124, 144. As shown in FIG. 4, the first winding 12 may be bent to form three turning corners 124 and the second winding 14 may be bent to form four turning corners 144, but the invention is not so limited. The first end 120 of the first winding 12 extends from a turning corner 124 of the first winding 12, such that the magnetic body 10 forms a triangular portion 106 adjacent to the first winding 12 after the first winding 12 is packaged in the magnetic body 10. The triangular portion 106 is configured to enhance magnetic characteristic of the magnetic component 1.

In this embodiment, a cross-section of the first winding 12 may be greater than a cross-section of the second winding 14. Furthermore, as shown in FIGS. 5 and 6, the first winding 12 and the second winding 14 may be covered by insulation layers 18a, 18b, wherein the first end 120, the second end 122, the third end 140 and the fourth end 142 are exposed from the insulation layers 18a, 18b. Still further, the first end 120, the second end 122, the third end 140 and the fourth end 142 exposed from the insulation layers 18a, 18b are formed with electrodes 20a, 20b, 20c, 20d. For example, the first end 120 may extend obliquely to form the electrode 20a, the second end 122 may extend vertically to form the electrode 20b, the third end 140 may extend horizontally to form the electrode 20c, and the fourth end 142 may extend vertically to form the electrode 20d, wherein the electrode 20c is located between the electrode 20a and the electrode 20d, and the electrode 20b is located opposite to the electrodes 20a, 20c, 20d. Since the third end 140 extends horizontally to form the electrode 20c and the fourth end 142 extends vertically to form the electrode 20d, the distance between the two electrodes 20c, 20d may be increased to reduce the risk of short circuit. The electrodes 20a, 20b, 20c, 20d may be electroplating electrodes essentially consisting of Cu, Ni and Sn from bottom to top, but the invention is not so limited. The material of the insulation layers 18a, 18b may be polymer glue, oxide, ceramic powder, etc. according to practical applications. It should be noted that the first winding 12 and the second winding 14 may be partially exposed from the bottom insulation layers 18a and 18b, such that the electrodes 20a, 20c, and 20d may be formed at the exposed first winding 12 and second winding 14, or alternatively, the first winding 12 and the second winding 14 may be wholly exposed from the bottom insulation layers 18a and 18b, such that the electrodes 20a, 20c, and 20d may be formed at the exposed first winding 12 and second winding 14.

The magnetic filler 16 is filled between the first winding 12 and the second winding 14. In this embodiment, the material of the magnetic filler 16 may be amorphous powder, nano-crystalline powder, carbonyl iron powder, alloy powder, high flux magnetic powder, sendust, molybdenum permalloy powder (MPP), ferrite; the composition may be C, Si, Cr, Fe, B, Co, Nb, Ni; and the construction may be a mixture of magnetic material and polymer glue (or glass beads, or ceramic powder, or oxide), or formed as a magnetic ribbon.

In this embodiment, two isolation grooves 22 may be formed on the first side 100 and the third side 104 of the magnetic body 10, wherein the two isolation grooves 22 are located between the first winding 12 and the second winding 14 and run through opposite sides of the magnetic body 10. Each of the two isolation grooves 22 comprises a gap 220 between the first winding 12 and second winding 14, wherein a cross-section of the gap 220 may be triangular. The magnetic filler 16 is also filled in the gap 220. The isolation grooves 22 are lower than the surface of the magnetic body 10 and lower than the electrodes. Furthermore, the isolation grooves 22 may exist between the first winding 12 and the second winding 14 and usually between two electrodes. The arrangement of the isolation grooves 22 can improve the withstand voltage between the first winding 12 and the second winding 14.

Since the magnetic filler 16 is filled between the first winding 12 and the second winding 14, the leakage inductance and the transient inductance of the magnetic component 1 can be controlled by adjusting the magnetic permeability of the magnetic filler 16 and/or by adjusting the gap 220 between the first winding 12 and second winding 14, thereby improving the electromagnetic coupling and voltage stability in a circuit.

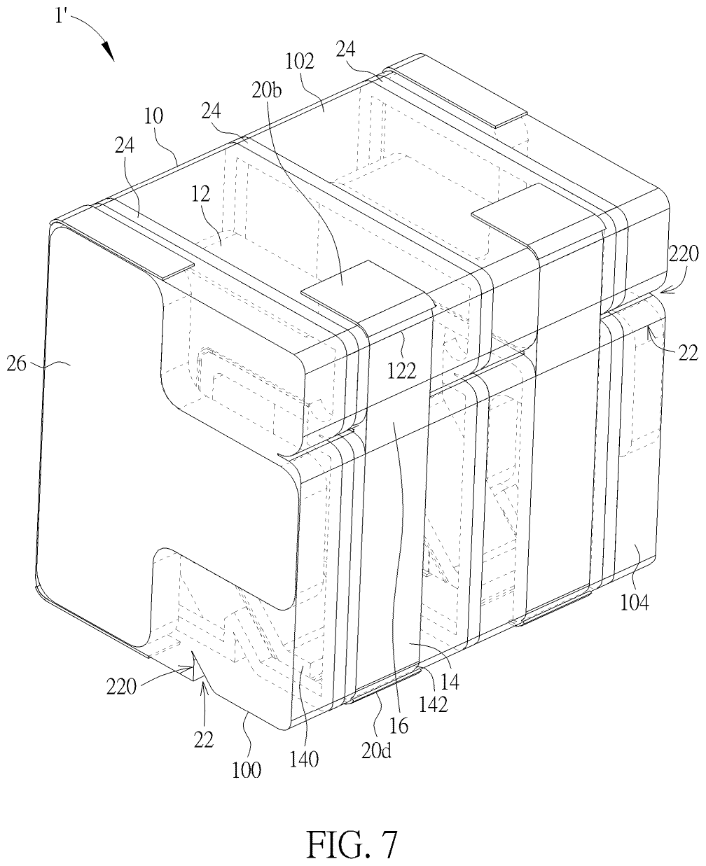

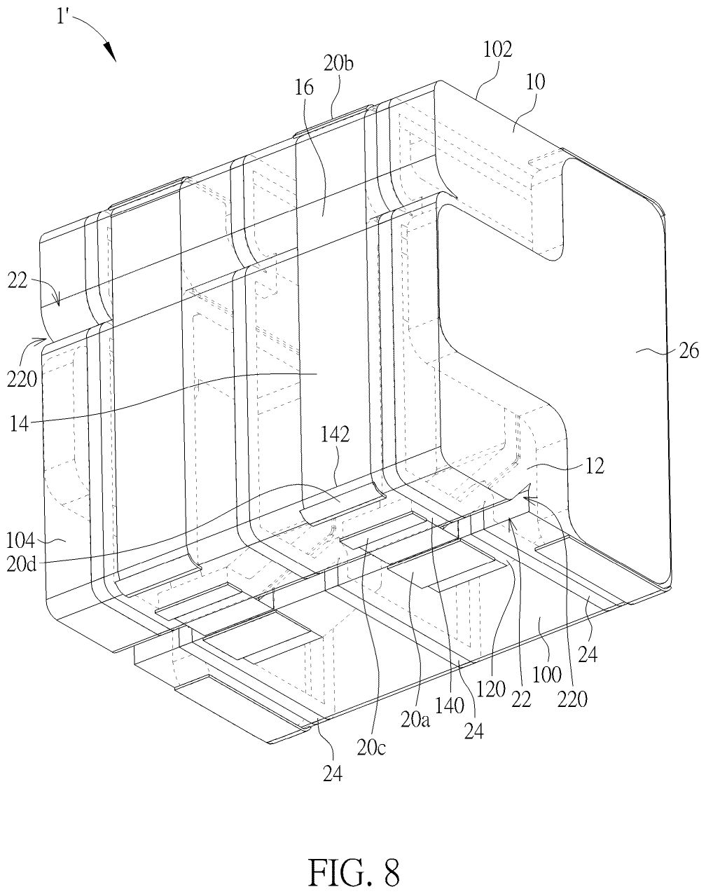

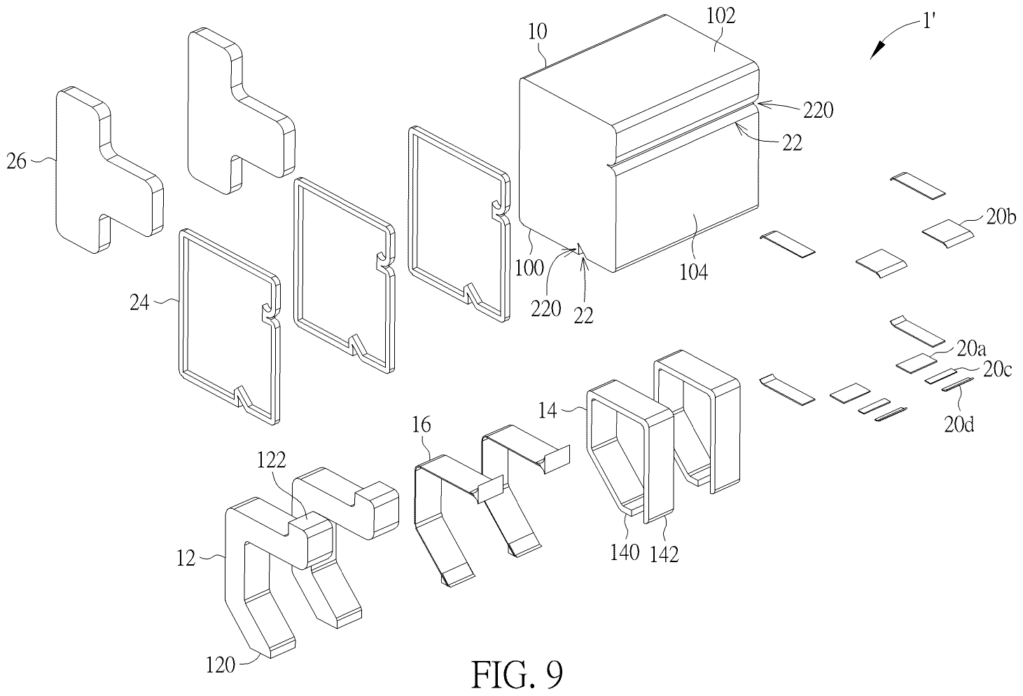

Referring to FIGS. 7 to 9, FIG. 7 is a perspective view illustrating a magnetic component 1′ according to another embodiment of the invention, FIG. 8 is a perspective view illustrating the magnetic component 1′ shown in FIG. 7 from another viewing angle, and FIG. 9 is an exploded view illustrating the magnetic component 1′ shown in FIG. 7.

As shown in FIGS. 7 to 9, the magnetic component 1′ comprises a magnetic body 10, a plurality of first windings 12, a plurality of second windings 14, a plurality of magnetic fillers 16 and a plurality of isolation rings 24. The first windings 12 are disposed in the magnetic body 10 and arranged at intervals, the second windings 14 are also disposed in the magnetic body 10 and arranged at intervals, and the first windings 12 respectively partially cover the second windings 14. Furthermore, the magnetic fillers 16 are filled between the first windings 12 and the second windings 14. In this embodiment, one of the first windings 12 and one of the second windings 14 may form a set of primary winding and secondary winding of the magnetic component 1′. Therefore, compared to the aforesaid magnetic component 1, the magnetic component 1′ of the invention may be an array inductor or other array magnetic components.

As mentioned in the above, a first end 120 and a second end 122 of each first winding 12 respectively extend towards a first side 100 and a second side 102 of the magnetic body 10. Similarly, a third end 140 and a fourth end 142 of each second winding 14 extend towards the first side 100 of the magnetic body 10. It should be noted that the same elements in FIGS. 7-9 and FIGS. 1-6 are represented by the same numerals, so the repeated explanation will not be depicted herein again.

In this embodiment, two isolation grooves 22 are still formed on the first side 100 and the third side 104 of the magnetic body 10, wherein the two isolation grooves 22 are located between the first windings 12 and the second windings 14 and run through opposite sides of the magnetic body 10. Each of the two isolation grooves 22 comprises a gap 220 between the first windings 12 and second windings 14, wherein a cross-section of the gap 220 may be triangular. The magnetic filler 16 is also filled in the gap 220.

Since the magnetic filler 16 is filled between the first windings 12 and the second windings 14, the leakage inductance and the transient inductance of the magnetic component 1′can be controlled by adjusting the magnetic permeability of the magnetic filler 16 and/or by adjusting the gap 220 between the first windings 12 and second windings 14, thereby improving the electromagnetic coupling and voltage stability in a circuit.

As shown in FIGS. 7 and 8, when the isolation rings 24 are packaged in the magnetic body 10, the isolation rings 24 surround a periphery of the magnetic body 10 and engage with the two isolation grooves 22. In this embodiment, each of the isolation rings 24 may be partially embedded in the magnetic body 10 and partially exposed from the magnetic body 10. The isolation grooves 22 and the isolation rings 24 may exist between the first windings 12 and the second windings 14 and usually between two electrodes. The arrangement of the isolation rings 24 and the isolation grooves 22 can improve the withstand voltage between the first windings 12 and the second windings 14. For further explanation, the isolation rings 24 are configured to block all paths of short circuit on the surface, thereby improving the withstand voltage of the magnetic component 1′. Furthermore, one of the first windings 12 and one of the second windings 14 are located between two of the isolation rings 24, such that the magnetic field lines of the first windings 12 and the second windings 14 will not be blocked by the isolation rings 24. In this embodiment, the isolation rings 24 may be made of insulation material, such as polymer, ceramic or other high resistivity materials.

In this embodiment, the magnetic component 1′ may further comprise two ground electrodes 26 disposed at opposite sides of the magnetic body 10, wherein the first windings 12 and the second windings 14 are located between the two ground electrodes 26.

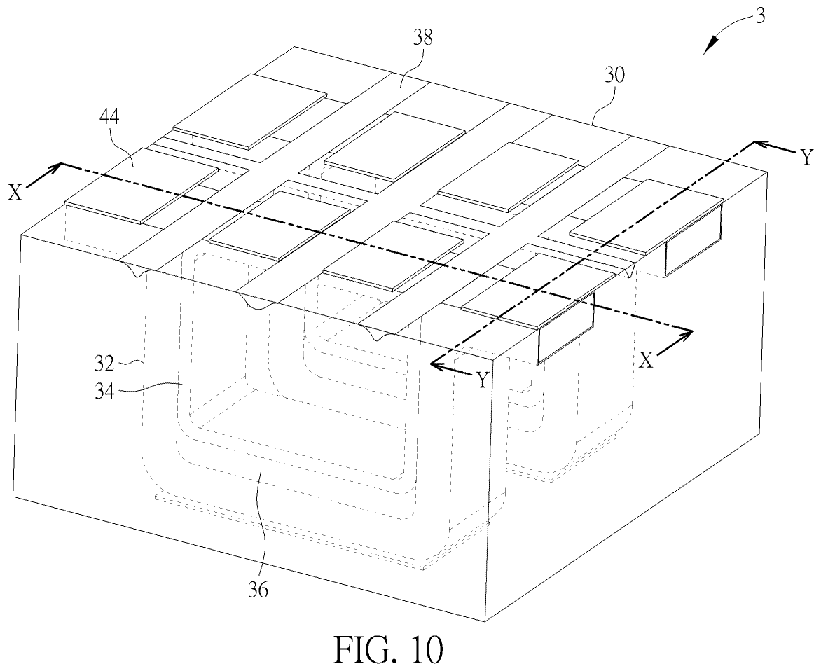

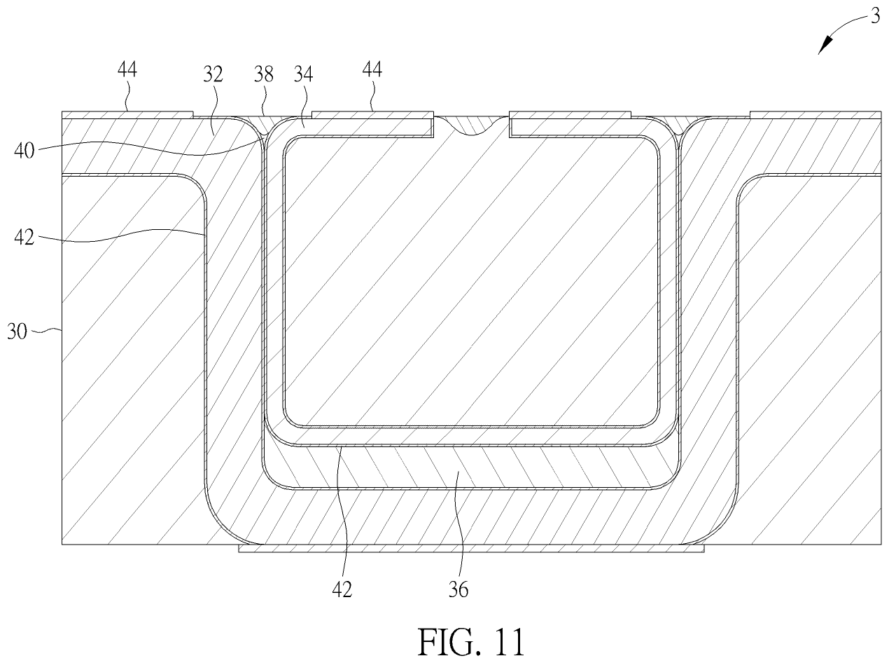

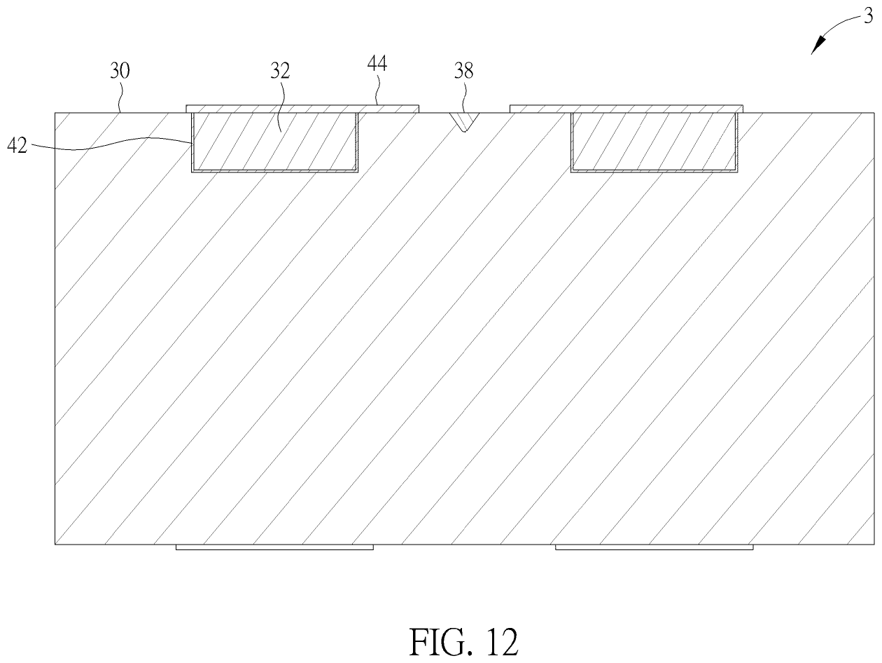

Referring to FIGS. 10 to 12, FIG. 10 is a perspective view illustrating a magnetic component 3 according to another embodiment of the invention, FIG. 11 is a sectional view illustrating the magnetic component 3 shown in FIG. 10 along line X-X, and FIG. 12 is a sectional view illustrating the magnetic component 3 shown in FIG. 10 along line Y-Y.

As shown in FIGS. 10 to 12, the magnetic component 3 comprises a magnetic body 30, a plurality of first windings 32, a plurality of second windings 34, a plurality of magnetic fillers 36 and an isolation strip 38. The first windings 32 are disposed in the magnetic body 30 and arranged at intervals, the second windings 34 are also disposed in the magnetic body 30 and arranged at intervals, and the first windings 32 respectively partially cover the second windings 34. Furthermore, the magnetic fillers 36 are filled between the first windings 32 and the second windings 34. In this embodiment, one of the first windings 32 and one of the second windings 34 may form a set of primary winding and secondary winding of the magnetic component 3. Therefore, the magnetic component 3 of the invention may be an array inductor or other array magnetic components.

After the first windings 32 and the second windings 34 (e.g. primary and secondary windings) are bonded, assembled and baked, the roots (e.g. triangular areas) between the first windings 32 and the second windings 34 may be filled with polymer adhesive 40 (e.g. polymer thermosetting adhesive). Furthermore, the first windings 32 and the second windings 34 (e.g. copper wires) may be fully covered with insulation layers 42 for blocking the internal short circuit path and the isolation strip 38 on the surface of the magnetic body 30 is used to block the surface short circuit path between every two electrodes 44 of the first windings 32 and the second windings 34, thereby increasing the withstand voltage between the electrodes 44. In this embodiment, the isolation strip 38 may be made of epoxy molding compounds (EMC) and formed with the magnetic body 30 integrally to be a part of the magnetic component 3.

As mentioned in the above, the magnetic filler is filled between the first winding and the second winding. Therefore, the invention can control the leakage inductance and the transient inductance of the magnetic component by adjusting the magnetic permeability of the magnetic filler and/or by adjusting the gap between the first winding and second winding, thereby improving the electromagnetic coupling and voltage stability in a circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic component comprising:
a magnetic body;
a first winding disposed in the magnetic body, a first end and a second end of the first winding respectively extending towards a first side and a second side of the magnetic body;
a second winding disposed in the magnetic body, a third end and a fourth end of the second winding extending towards the first side of the magnetic body, the first winding partially covering the second winding; and
a magnetic filler filled between the first winding and the second winding.

2. The magnetic component of claim 1, wherein a number of turns of the first winding are less than one.

3. The magnetic component of claim 1, wherein a number of turns of the second winding are less than or equal to one.

4. The magnetic component of claim 1, wherein the first side is opposite to the second side.

5. The magnetic component of claim 1, wherein two isolation grooves are formed on the first side and a third side of the magnetic body, are located between the first winding and the second winding, and run through the magnetic body; wherein the third side is connected between the first side and the second side.

6. The magnetic component of claim 5, wherein each of the two isolation grooves comprises a gap and the magnetic filler is filled in the gap.

7. The magnetic component of claim 6, wherein a cross-section of the gap is triangular.

8. The magnetic component of claim 1, wherein the first end extends from a turning corner of the first winding, such that the magnetic body forms a triangular portion adjacent to the first winding.

9. The magnetic component of claim 1, wherein the third end extends horizontally to form an electrode and the fourth end extends vertically to form another electrode.

10. The magnetic component of claim 1, wherein the first winding and the second winding are covered by insulation layers; wherein the first end, the second end, the third end and the fourth end exposed from the insulation layers are formed with electrodes.

11. The magnetic component of claim 1, wherein a cross-section of the first winding is greater than a cross-section of the second winding.

12. A magnetic component comprising:
a magnetic body;
a plurality of first windings disposed in the magnetic body and arranged at intervals, a first end and a second end of each of the plurality of first windings respectively extending towards a first side and a second side of the magnetic body;
a plurality of second windings disposed in the magnetic body and arranged at intervals, a third end and a fourth end of each of the plurality of the second windings extending towards the first side of the magnetic body, the plurality of first windings respectively partially covering the plurality of second windings; and
a plurality of magnetic fillers filled between the plurality of first windings and the plurality of second windings.

13. The magnetic component of claim 12, wherein two isolation grooves are formed on the first side and a third side of the magnetic body, are located between the plurality of first windings and the plurality of the second windings, and run through the magnetic body; wherein the third side is connected between the first side and the second side.

14. The magnetic component of claim 13, wherein each of the two isolation grooves comprises a gap and the plurality of magnetic fillers are filled in the gap.

15. The magnetic component of claim 14, wherein a cross-section of the gap is triangular.

16. The magnetic component of claim 13, further comprising a plurality of isolation rings surrounding a periphery of the magnetic body, wherein the plurality of isolation rings engage with the two isolation grooves.

17. The magnetic component of claim 16, wherein one of the plurality of first windings and one of the plurality of second windings are located between two of the plurality of isolation rings.

18. The magnetic component of claim 16, wherein each of the plurality of isolation rings is partially embedded in the magnetic body and partially exposed from the magnetic body.

19. The magnetic component of claim 16, wherein the plurality of isolation rings are made of insulation material.

20. The magnetic component of claim 12, further comprising two ground electrodes disposed at opposite sides of the magnetic body, wherein the plurality of first windings and the plurality of second windings are located between the two ground electrodes.

21. The magnetic component of claim 12, wherein a number of turns of each of the plurality of first windings are less than one.

22. The magnetic component of claim 12, wherein a number of turns of each of the plurality of second windings are less than or equal to one.

23. The magnetic component of claim 12, wherein the first side is opposite to the second side.
